(19) United States
(12) Patent Application Publication
(10) Pub. No.: US 2026/0338541 A1
(43) Pub. Date: Oct. 29, 2026

(54) METHOD AND APPARATUS FOR MEASURING A WORKPIECE BY SELECTING MEASUREMENT DATA FROM A DISTANCE SENSOR

(71) Applicant: JENOPTIK Optical Systems GmbH, Jena (DE)

(72) Inventors: Lutz JACOB, Jena (DE); Michael SCHUBERT, Jena (DE); Yushan MIAO, Jena (DE)

(73) Assignee: JENOPTIK Optical Systems GmbH, Jena (DE)

(21) Appl. No.: 19/660,954

(22) Filed: Apr. 28, 2026

(30) Foreign Application Priority Data
Apr. 29, 2025 (DE) 10 2025 001 490.2

(51) Int. Cl. G01B 11/04; G01B 11/00; G01B 11/02; G01B 11/06; G01B 11/24

(52) U.S. Cl. CPC G01B 11/04; G01B 11/005; G01B 11/026; G01B 11/0691; G01B 11/24

(57) ABSTRACT

A method for measuring at least one feature of the shape, position or dimension of a rotatably clamped workpiece is provided. Measured values are recorded for generating a first data set which describes the at least one feature of the shape, position or dimension of the workpiece. A distance sensor is provided in a distance sensor position and at a distance sensor angle. Measurement data is read from the distance sensor in order to determine the distance between the distance sensor and a surface position on the surface of the workpiece. An unambiguously determinable distance value is determined and the unambiguously determinable distance value is selected as the distance or a plurality of possible distance values are determined and the possible distance value closest to a target value as the distance is selected.

This nonprovisional application claims priority under 35 U.S.C. § 119(a) to German Patent Application No. 10 2025 001 490.2, which was filed in Germany on Apr. 29, 2025, and which is herein incorporated by reference.

### BACKGROUND OF THE INVENTION

### Field of the Invention

The invention relates to a method and an apparatus for measuring the shape, position or dimension of a workpiece, in particular of rotatable machine elements, such as motor and transmission shafts, thrust rods, valves, pistons, screws, turbine parts etc.

### DESCRIPTION OF THE BACKGROUND ART

For an accurate measurement of wavy workpieces, tactile measurement methods have become established in which surfaces can be probed with mechanical probing elements and measured very accurately. Use is also made of contactless measurement methods for distance measurement, for example optical distance sensors.

Optical measurement methods which produce a shadow image of the workpiece, on which the outer contour can be measured, are suitable for supplementation. Due to the contactless measurement, the workpiece can be detected quickly and measured with high accuracy. It is possible to easily and quickly switch between different measurement tasks. A disadvantage of the shadow image is that, for example, concave partial surfaces and undercuts which are not visible in the shadow image cannot be measured.

It is therefore appropriate to combine the measurement method with distance measurement by means of a distance sensor and the measurement method with a shadow image. By rotating the wavy workpiece about its longitudinal axis and repeatedly measuring the distance and recording shadow images, its shape and dimensions can be completely captured.

DE 10 2012 104 008 B3, which corresponds to US 2013/0300861, which is incorporated herein by reference, discloses an apparatus for measuring the shape and dimensions of a rotatable wavy workpiece, in which the measurement method with a shadow image and the measurement method with distance measurement by means of a distance sensor can be carried out in combination. The apparatus contains a machine bed with a linear guide arranged along the machine bed and a linear guide system arranged parallel thereto, a workpiece holder for rotatably receiving the workpiece and an optical measuring unit with an illumination module and a camera module for recording shadow images of the workpiece. In addition, the apparatus contains an additional mechanical measuring unit with a tactile distance sensor, wherein the mechanical measuring unit is fixed to the optical measuring unit and has a pivoting device for pivoting the tactile distance sensor in a plane orthogonal to the axis of rotation of the workpiece.

WO 2022/053929, which corresponds to US 2023/0324169, discloses an apparatus for measuring the shape and dimensions of a rotatable wavy workpiece, in which the measurement method with a shadow image and the measurement method with distance measurement by means of a distance sensor can be carried out in combination. The distance sensor is in this case in the form of an optical distance sensor. The distance sensor is mounted displaceably and rotatably on a holder. Thus, the distance sensor can be aligned in a suitable angular range with respect to the surface of a region of the workpiece to be measured, for example aligned with the flanks of a tooth of a gear wheel.

Optical distance sensors according to the CCS principle, i.e. confocal chromatic sensors, are known. The principle is based on the dispersion of the medium of lenses. A surface position of the workpiece, the distance of which from the distance sensor is intended to be measured, is illuminated with broad-spectrum light. The surface position is imaged confocally onto a spectrometer sensor which measures the spectrum of the imaged surface position. The focal length of a lens system used for imaging depends on the wavelength of the light. Therefore, the distance between the surface position and the distance sensor can be calculated from the spectrum of the imaged surface position.

Likewise known are optical time-of-flight distance sensors which measure the time-of-flight of the light from the distance sensor to the surface position and back and calculate the distance between the surface position and the distance sensor therefrom.

The use of an optical distance sensor is advantageous compared to a tactile distance sensor if the measurement time is intended to be short and the surface of the workpiece is not intended to be touched mechanically. In the case of an optical distance sensor, the path length which is traveled by a measurement beam from the distance sensor to the workpiece and, after reflection at the workpiece, back to the distance sensor is measured. In this case, however, multiple reflections at the workpiece can occur, which make the measured path length and thus the result of the distance measurement ambiguous or unreliable. The methods known from the prior art for measuring the shape, position or dimension of a rotatable workpiece do not disclose any method steps as to how to deal with these multiple reflections in order to obtain high reliability of the distance measurement. Thus, the measured data relating to the shape, position or dimension of the workpiece are not reliable.

### SUMMARY OF THE INVENTION

It is therefore an object of the invention to provide a method for measuring the shape, position or dimension of a workpiece, which method yields an unambiguous result of the distance measurement with the distance sensor. A reliable data set of the shape, position or dimension of the workpiece is thus intended to be generated.

The method according to the invention for measuring at least one feature of the shape, position or dimension of a rotatably clamped workpiece comprises recording measured values for generating a first data set which describes the at least one feature of the shape, position or dimension of the workpiece,

wherein recording measured values comprises: providing a distance sensor in a distance sensor position and at a distance sensor angle; reading measurement data from the distance sensor in order to determine the distance between the distance sensor and a surface position on the surface of the workpiece; determining the distance between the distance sensor and the surface position from the measurement data; calculating a coordinate set of the surface position from the distance, the distance sensor position and the distance sensor angle; generating the first data set from the coordinate set of the surface position; wherein determining the distance comprises the following steps: checking the measurement data for the presence of an ambiguity in the determination of the distance, wherein a plurality of possible distance values of the distance can be determined if the ambiguity is present; determining an unambiguously determinable distance value and selecting the unambiguously determinable distance value as the distance or determining a plurality of possible distance values and selecting the possible distance value closest to a target value as the distance.

The distance sensor can be controlled by a control unit for reading measurement data.

The at least one feature of the shape, position or dimension of the workpiece can be, in particular, a quantitative feature. The at least one feature can be, for example, a diameter of the workpiece or a coordinate of a tooth of a gear wheel mounted on a shaft of the workpiece. The workpiece can be, in particular, a wavy workpiece.

In the method according to the invention, it is checked whether the distance between the surface position and the distance sensor can be determined unambiguously, i.e. whether there is an ambiguity in the determination of the distance. If the distance can be determined unambiguously, only an unambiguously determinable distance value is determined. The unambiguously determinable distance value is selected as the distance between the surface position and the distance sensor. On the other hand, if the ambiguity is present, a plurality of possible distance values can be determined. When selecting, that possible distance value which is closest to a target value is selected as the distance.

The target value can be determined from target data relating to the workpiece, the distance sensor position and the distance sensor angle.

In the method according to the invention, the measurement data can be present as a sequence of measured values, wherein the sequence of measured values has one or more local extrema, wherein, if the sequence has a plurality of local extrema, the determination of the distance is ambiguous, wherein the unambiguously determinable distance value can be determined from the local extremum or the plurality of possible distance values can be determined from the plurality of local extrema.

In the method according to the invention, if the ambiguity is present, the plurality of possible distance values are compared with a target value of the distance between the surface position and the distance sensor. The target value of the distance can be calculated taking into account target data relating to the workpiece, in particular taking into account design data relating to the workpiece. The target position of the surface position can be calculated from the target data relating to the workpiece, for example in the form of CAD data. It can be assumed that the actual position of the surface position deviates only slightly from the target position. Therefore, the target value of the distance between the surface position and the distance sensor can be calculated from the target data relating to the workpiece, the distance sensor position and the distance sensor angle of the distance sensor.

The target value of the distance from the surface position can also be determined from an average value of coordinate sets of further surface positions which are adjacent to the surface position, wherein the distance sensor position and the distance sensor angle are included in the determination of the target value of the distance.

The distance sensor can output the measurement data as a sequence of measured values from which the distance can be determined. In particular, the distance can be determinable as an unambiguously determinable distance value from an extremum of the sequence of measurement data, i.e. from a maximum or a minimum of the sequence of measured values. If there is an ambiguity when determining the distance, the sequence of measured values has a plurality of local extrema, i.e. a plurality of local maxima or a plurality of local minima. From the plurality of local extrema, it is possible to determine a plurality of possible distance values, from which that possible distance value which is closest to the target value of the distance is selected as the distance.

The sequence of measured values can have a plurality of local extrema if, as a result of multiple reflections of the light emanating from the distance sensor at the workpiece, the light passes back to the distance sensor on different paths and these different paths have different optical path lengths. In this case, there is an ambiguity when determining the distance.

In the method according to the invention, the distance sensor can carry out a contactless measurement of the distance, in particular an optical measurement of the distance. The distance sensor for carrying out the contactless measurement of the distance can be a confocal chromatic sensor. The distance sensor for carrying out the contactless measurement of the distance can be an optical time-of-flight distance sensor.

In the method according to the invention, the distance sensor can carry out a contactless measurement of the distance, in particular an optical measurement of the distance. An optical measurement of the distance can be carried out according to the CCS principle, i.e. according to the principle of a confocal chromatic distance sensor. A confocal chromatic distance sensor according to the CCS principle is advantageous on account of the high accuracy, short measurement time and small size of the distance sensor. An optical measurement of the distance can also be carried out by way of a time-of-flight measurement of the light. An optical measurement can also be carried out with a laser range finder. In this case, the distance can be determined from a shift of the phase angle of amplitude modulation of the laser radiation between the emitted and received laser beam, in order to achieve better resolution. A contactless measurement of the distance can also be performed by measuring the propagation time of a sound signal or by means of a compressed air pulse. In the latter case, a measured dynamic pressure can be converted into a distance.

In the case of an optical distance sensor according to the CCS principle, the surface position is imaged confocally onto a spectrometer sensor which measures the spectrum of the imaged surface position. The measurement data are output as a sequence of measured values of the spectrum. The sequence of measured values of the spectrum has one or more local extrema from which the distance can be determined. If there is an ambiguity when determining the distance, the sequence of measured values of the spectrum has a plurality of local extrema. The ambiguity can be caused by multiple reflections of the light at the workpiece and different optical path lengths of the different paths. From the plurality of local extrema, it is possible to determine a plurality of possible distance values, from which that possible distance value which is closest to the target value is selected as the distance in the method according to the invention.

An ambiguity when determining the distance may also occur when using other distance sensors, for example a distance sensor that uses a time-of-flight measurement of the light. The method according to the invention can also be used with other distance sensors.

The method according to the invention can additionally comprise illuminating the workpiece using an illumination unit and recording a shadow image of the workpiece using a sensor unit. The sensor unit, for example a planar CCD camera or a line scan camera, is located on that side of the workpiece which lies opposite the illumination unit. Advantageously, the illumination can be effected with parallel light. A particularly accurate shadow image can then be recorded. Alternatively, the illumination can be effected with a point light source. Then, the shadow image can be dependent on the position of the illumination unit and the recording plane of the sensor unit.

During the illumination of the workpiece using the illumination unit, the generated shadow image of the workpiece can be recorded in a recording using the sensor unit. A second data set can be generated from this recording. The second data set can comprise at least one feature of the shape, position or dimension of the workpiece, for example a diameter of the workpiece. The first data set and the second data set can be combined to form a third data set, wherein the third data set describes the at least one feature of the shape, position or dimension of the workpiece.

In the method according to the invention, the first data set can contain in particular at least one feature relating to the shape, position or dimension of the workpiece that is not contained in the second data set generated from the at least one shadow image. This can be a feature relating to the shape, position or dimension of concave partial surfaces and/or undercuts.

In the method according to the invention, a first coordinate system of the distance sensor and a second coordinate system of the sensor unit can be matched on the basis of a reference position. The reference position is a surface position on the surface of the workpiece, the coordinate set of which can be determined using both the distance sensor and the sensor unit. The reference position can be, for example, a tip attached to the workpiece or a surface position on a ring attached to the workpiece. The reference position can be selected as the surface position, and the reference position can be recorded as a shadow image by the sensor unit. The first data set can be generated using the distance sensor in the method according to the invention, wherein the first data set contains a coordinate set of the reference position in the first coordinate system. The second data set can be generated using the sensor unit in the method according to the invention, wherein the second data set contains a coordinate set of the reference position in the second coordinate system. A relationship between the distance sensor and the sensor unit can therefore be calculated from the combination of the first data set and the second data set in the third data set. This relationship can be, for example, an offset and/or a rotation between the first coordinate system and the second coordinate system.

The distance sensor can be mounted on a carrier. The distance sensor can be statically mounted on the carrier. Optionally, the distance sensor can be mounted on a displacement and rotation unit and can be controlled displaceably and/or rotatably into a distance sensor position and a distance sensor angle by means of a control unit. The optional illumination unit and the optional sensor unit can likewise be mounted on this carrier opposite one another. The carrier may be U-shaped and encompass the workpiece.

In the method according to the invention, the workpiece can be rotated about an axis of rotation. In the case of a wavy workpiece, the axis of rotation is advantageously along the long direction of the wavy workpiece. Likewise, the distance sensor can be displaced in a direction along the axis of rotation. Likewise, the illumination unit and/or the sensor unit can be displaced in a direction along the axis of rotation. As a result, further features of the shape, position or dimension of the workpiece can be measured.

The following can be carried out on a control unit, which can be embodied as a control and evaluation unit, and/or a computer: controlling the distance sensor by means of a control unit for reading measurement data; recording, reading and/or processing measurement data from the distance sensor; determining the distance between the distance sensor and the surface position from the measurement data; calculating the coordinate set of the surface position from the distance, the distance sensor position and the distance sensor angle; generating the first data set from the coordinate set of the surface position; checking the measurement data for the presence of an ambiguity in the determination of the distance; determining the unambiguously determinable distance value or the plurality of possible distance values; selecting the unambiguously determinable distance value or the possible distance value as the distance; and/or generating the second data set from the at least single recording of the shadow image; and/or combining the first data set and the second data set to form the third data set.

An apparatus according to the invention for measuring at least one feature of the shape, position or dimension of a rotatably clamped workpiece comprises a distance sensor and a control unit, on which the method according to the invention can be carried out. The distance sensor can be displaceable and/or rotatable. The apparatus according to the invention can comprise an illumination unit and a sensor unit.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an apparatus for measuring the shape, position or dimension of the workpiece, on which the method according to the invention can be carried out;

FIG. 2 shows a view of the distance sensor;

FIG. 3 shows a view of the distance sensor and of the workpiece and the presence of an ambiguity when determining the distance;

FIGS. 4(a) and 4(b) show a selection of possible distance values for determining a distance;

FIG. 5 shows a flowchart of the method according to the invention; and

FIG. 6 shows a further flowchart of the method according to the invention.

### DETAILED DESCRIPTION

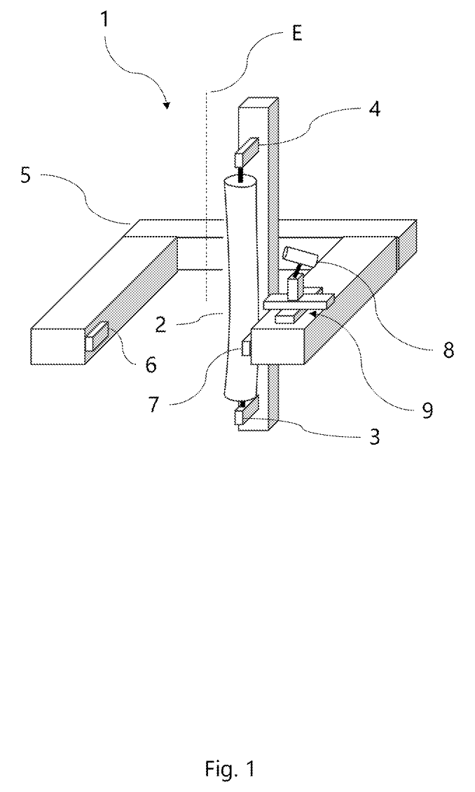

FIG. 1 shows an apparatus 1 for measuring the shape, position or dimension of a workpiece 2, on which the method according to the invention can be carried out. The workpiece 2 shown in FIG. 1 is a wavy workpiece. The workpiece 2 is rotatably clamped between two holders 3, 4, wherein the rotation takes place about an axis parallel to a direction E. Alternatively, the workpiece 2 can also be rotatably clamped in only one holder. A U-shaped carrier 5 encompasses the workpiece 2. A sensor unit 6 and an illumination unit 7 are mounted on the carrier 5. The carrier 5 is displaceable along the direction E. The sensor unit 6, for example a planar CCD camera or a line scan camera, is located on that side of the workpiece 2 which lies opposite the illumination unit 7. A distance sensor 8 is mounted on the carrier 5 by means of a mounting unit. The mounting unit can be static. Optionally, the mounting unit can be embodied as a displacement and rotation unit 9 and the distance sensor 8 can thus be displaceable and rotatable. In the example illustrated in FIG. 1, the mounting unit is embodied as a displacement and rotation unit 9.

The sensor unit 6 and the illumination unit 7 are not required for carrying out the method according to the invention.

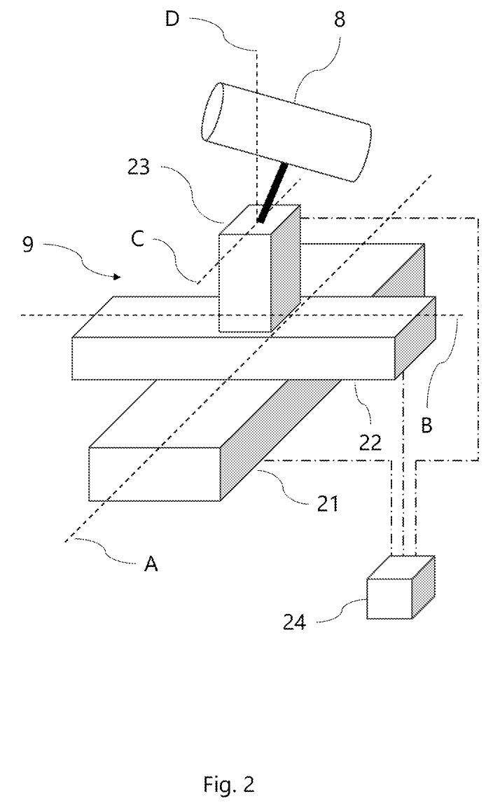

FIG. 2 shows the mounting unit with the mounted distance sensor 8, wherein the mounting unit in this example is embodied as a displacement and rotation unit 9. The displacement and rotation unit 9 comprises a displacement element 21, a displacement element 22 and a rotation element 23. The displacement element 22 is mounted on the displacement element 21 and is displaceable along the direction A. The displacement element 22 is mounted substantially perpendicular to the direction A. The rotation element 23 is mounted on the displacement element 22 and is displaceable along the direction B. Direction A and direction B are substantially perpendicular to one another and also substantially perpendicular to the direction E. The distance sensor 8 is mounted on the rotation element 23 and is rotatable about the axis C and the axis D. The axis C is substantially parallel to the direction A. The axis D is substantially parallel to the direction E. Thus, the distance sensor 8 is displaceable along direction A and direction B and is rotatable about axis C and axis D. Displacement element 21, displacement element 22 and rotation element 23 are controlled by a control unit 24.

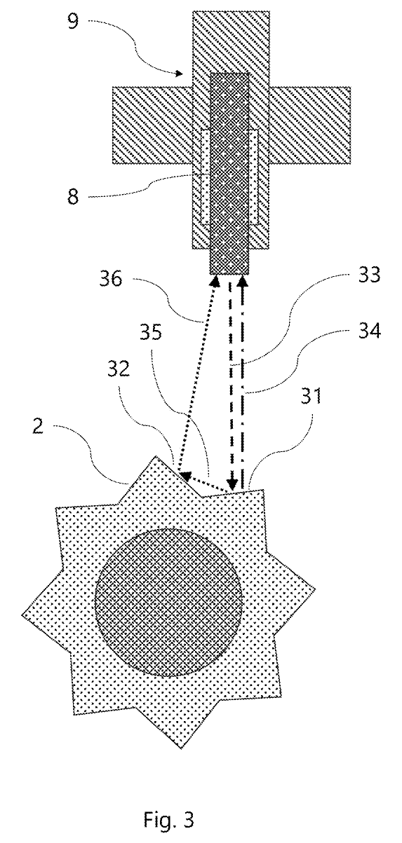

FIG. 3 shows the distance sensor 8 on the displacement and rotation unit 9 when measuring a distance between the distance sensor 8 and a surface position 31 on the surface of the workpiece 2. The distance sensor 8 carries out an optical measurement of the distance. A light beam 33 is applied to the surface position 31 by the distance sensor 8. The light reflected at the surface position 31 reaches the distance sensor 8 again in the light beam 34. A portion of the light reflected at the surface position 31 likewise reaches the distance sensor 8 in a multiple reflection in the light beams 35 and 36 after reflection at a surface position 32. Light thus passes into the distance sensor 8 on two paths both via the light beam 34 and via the light beams 35 and 36. The optical path lengths of the two paths are different. Thus, there is an ambiguity when determining the distance.

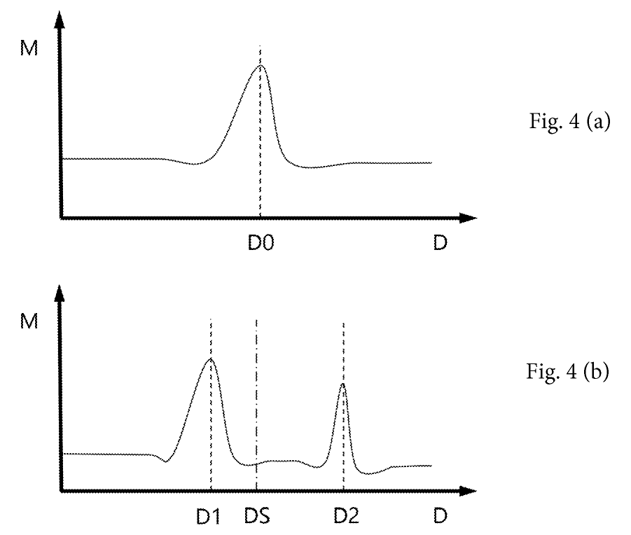

FIGS. 4(a), 4(b) show measurement data for determining a distance between the distance sensor 8 and a surface position on the surface of the workpiece 2. The measurement data are plotted as a sequence of measured values M as a function of a distance value D. The sequence of measured values M can be output by a spectrometer sensor, for example, if a distance sensor according to the CCS principle is used. In this case, the distance value D can be calculated from the wavelength calibration of the spectrometer sensor using the dispersion of the lens system.

FIGS. 4(a) shows a sequence of measured values M when there is no ambiguity when determining the distance. The sequence of measured values M has a local extremum in the form of a local maximum at a distance value D0. The distance between the surface position and the distance sensor 8 can thus be unambiguously determined. The distance value D0 is selected as the distance between the surface position and the distance sensor 8.

FIGS. 4(b) shows a sequence of measured values M when there is an ambiguity when determining the distance, as can occur, for example, in the arrangement shown in FIG. 3. The sequence of measured values M has two local extrema in the form of local maxima. The first local maximum at a distance value D1 corresponds to a path via the light beam 33 and the light beam 34. The second local maximum at the distance value D2 corresponds to a path via the light beam 33, the light beam 35 and the light beam 36 and is a consequence of multiple reflection at the workpiece 2. A target value DS is calculated from the target data relating to the workpiece 2, in particular from the design data relating to the workpiece, for example CAD data. The distance value D1 is closer to the target value DS than the distance value D2. Therefore, the distance value D1 is selected as the distance between the surface position 31 and the distance sensor 8.

FIGS. 4(b) shows, by way of example, two local extrema in the form of local maxima at distance values D1 and D2. Further local extrema may occur, such that the sequence of measured values M may have local maxima or minima at distance values D1, D2, … DN.

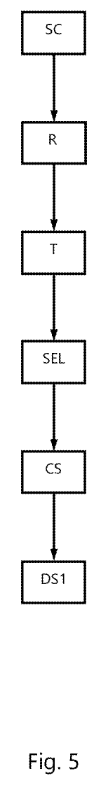

FIG. 5 shows the method according to the invention in a flowchart. The control unit 24 controls the distance sensor 8 into the configuration SC, wherein the configuration SC comprises a distance sensor position and a distance sensor angle. In method step R, measurement data from the distance sensor 8 are read in order to determine the distance between the distance sensor 8 and a surface position 31 on the surface of the workpiece 2. In the following method step T, the measurement data are checked for the presence of an ambiguity in the determination of the distance. In the subsequent method step SEL, either the unambiguously determinable distance value or one of the possible distance values is selected as the distance. A coordinate set CS of the surface position 31 is then calculated from the distance, the distance sensor position and the distance sensor angle, and a first data set DS1 is generated from the coordinate set CS.

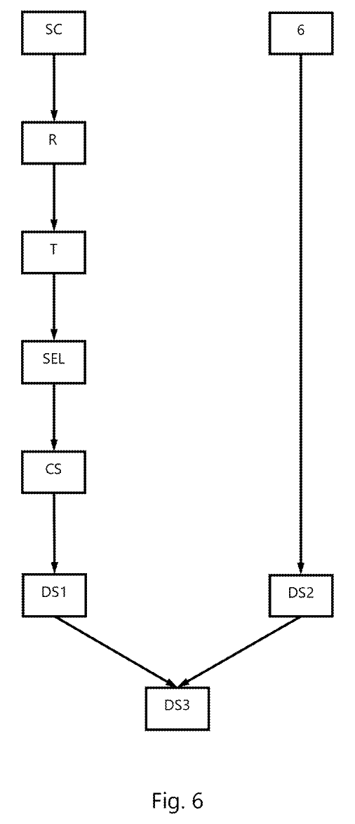

FIG. 6 shows the method according to the invention with additional recording of a shadow image using the sensor unit 6. The illumination unit 7 illuminates the workpiece 2, and the sensor unit 6 records a shadow image of the workpiece 2. A second data set DS2 is generated from the shadow image. The second data set DS2 contains information about the shape, position or dimension of the workpiece 2, which can be calculated from the shadow image, for example the diameter of the workpiece 2.

The first data set DS1 is calculated in accordance with the description of FIG. 5.

The first data set DS1 and the second data set DS2 are combined to form a third data set DS3, wherein the third data set DS3 describes at least one feature of the shape, position or dimension of the workpiece 2.

In particular, the first data set DS1 can comprise information about at least one feature of the shape, position or dimension of the workpiece 2 that is not contained in the second data set DS2 generated from the at least one shadow image. In particular, the first data set DS1 can comprise information about a surface position in a concave or undercut region of the workpiece 2.

The method according to the invention is not restricted to the examples shown.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for measuring at least one feature of a shape, position or dimension of a rotatably clamped workpiece, the method comprising:
recording measured values for generating a first data set that describes the at least one feature of the shape, position or dimension of the workpiece;
providing a distance sensor in a distance sensor position and at a distance sensor angle;
reading measurement data from the distance sensor in order to determine the distance between the distance sensor and a surface position on the surface of the workpiece;
determining the distance between the distance sensor and the surface position from the measurement data;
calculating a coordinate set of the surface position from the distance, the distance sensor position and the distance sensor angle; and
generating the first data set from the coordinate set of the surface position,
wherein determining the distance comprises the following steps:
checking the measurement data for the presence of an ambiguity in the determination of the distance, wherein a plurality of possible distance values of the distance can be determined if the ambiguity is present;
determining an unambiguously determinable distance value and selecting the unambiguously determinable distance value as the distance; or
determining a plurality of possible distance values and selecting the possible distance value closest to a target value as the distance.

2. The method as claimed in claim 1, wherein the measurement data are present as a sequence of measured values, wherein the sequence of measured values has one or more local extrema, wherein, if the sequence has a plurality of local extrema, the determination of the distance is ambiguous, and wherein the unambiguously determinable distance value can be determined from the local extremum or the plurality of possible distance values can be determined from the plurality of local extrema.

3. The method as claimed in claim 1, wherein the target value is determined from target data relating to the workpiece, the distance sensor position, and the distance sensor angle.

4. The method as claimed in claim 1, wherein the target value is determined from an average value of coordinate sets of further surface positions which are adjacent to the surface position, the distance sensor position, and the distance sensor angle.

5. The method as claimed in claim 1, wherein the distance sensor carries out a contactless measurement of the distance, or an optical measurement of the distance.

6. The method as claimed in claim 5, wherein the distance sensor is a confocal chromatic distance sensor.

7. The method as claimed in claim 1, wherein the distance sensor is controllable in a displaceable and/or rotatable manner into a distance sensor position and a distance sensor angle.

8. The method as claimed in claim 1, further comprising:
rotating the workpiece about an axis of rotation of the rotatably clamped workpiece and/or displacing the distance sensor in a direction along the axis of rotation.

9. The method as claimed in claim 1, further comprising:
illuminating the workpiece using an illumination unit;
recording a shadow image of the workpiece, which is generated by the illumination unit, at least a single time using a sensor unit;
generating a second data set from the at least single recording of the shadow image; and
combining the first data set and the second data set to form a third data set, the third data set describing the at least one feature of the shape, position or dimension of the workpiece.

10. The method as claimed in claim 9, wherein the workpiece comprises a reference surface, wherein the reference surface is visible in the shadow image of the workpiece that is recorded by the sensor unit, and a position on the reference surface is selected as the surface position, and wherein the method further comprises:
calculating a relationship between the distance sensor and the sensor unit from the at least one feature of the shape, position or dimension of the workpiece that is described in the third data set.

11. An apparatus for measuring at least one feature of the shape, position or dimension of a rotatably clamped workpiece, the apparatus comprising:
a distance sensor; and
a control unit on which the method as claimed in claim 1 is carried out.

12. The apparatus as claimed in claim 11, wherein the distance sensor is displaceable and/or rotatable.

13. The apparatus as claimed in claim 11, further comprising an illumination unit and a sensor unit.
